(19) United States
(12) Patent Application Publication
(10) Pub. No.: US 2025/0350397 A1
(43) Pub. Date: Nov. 13, 2025

(54) METHODS AND SYSTEMS FOR MCS ASSIGNMENT IN WIRELESS NETWORKS

(71) Applicant: SAMSUNG ELECTRONICS CO., LTD., Suwon-si (KR)

(72) Inventors: Anand JEE, Bangalore (IN); Aniruddh Rao KABBINALE, Bangalore (IN); Karthik Srinivasa GOPALAN, Bangalore (IN)

(21) Appl. No.: 19/275,786

(22) Filed: Jul. 21, 2025

Related U.S. Application Data
(63) Continuation of application No. PCT/KR2025/006062, filed on May 7, 2025.

(30) Foreign Application Priority Data
May 7, 2024 (IN) 202441036238
Apr. 24, 2025 (IN) 202441036238

(51) Int. Cl. H04L 1/00; H04L 5/00

(52) U.S. Cl. CPC H04L 1/0003; H04L 5/0025

(57) ABSTRACT

Embodiments disclose methods for assigning an unequal modulation and coding scheme (MCS) in a wireless network by a user equipment (UE). The method includes determining a maximum difference in an MCS index allowed across different spatial streams per user and determining a type of unequal MCS enabled at the UE. The method includes identifying a primary spatial stream, based on the type of unequal MCS enabled at the UE. Further, the method includes enabling assignment of the at least one MCS index to all the spatial streams based on at least one of the maximum difference in the MCS index allowed across different spatial streams per user, the type of unequal MCS enabled at the UE, or the identification of the primary spatial stream.

### CROSS REFERENCE TO RELATED APPLICATION

This application is a continuation application of International Application No. PCT/KR2025/006062 designating the United States, filed on May 7, 2025 in the Korean Patent Office and claiming priority to Indian Provisional Application No. 202441036238 filed on May 7, 2024 in the Intellectual Property India Office, and Indian Complete Patent Application No. 202441036238 filed on Apr. 24, 2025, all of which are incorporated by reference herein in their entireties.

### TECHNICAL FIELD

This disclosure relates to a wireless communication network, and more particularly to methods and systems for assigning an unequal modulation and coding scheme (MCS) in the wireless local area network (WLAN).

### BACKGROUND

Wireless local area networks (WLAN) technology has evolved towards increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

To implement extremely low latency and extremely high throughput for some applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA. The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

Currently, in WLAN, a modulation and coding scheme (MCS) in wireless communication defines a transmission of data over a wireless channel. The MCS combines two aspects of modulation and coding. In some examples, modulation is a process of varying a carrier signal is performed to encode data. Some examples of modulation schemes include a Binary Phase Shift Keying (BPSK), a Quadrature Phase Shift Keying (QPSK), or a Quadrature Amplitude Modulation (QAM). In some cases, coding is a process of defining how the data is being encoded. That is, coding adds some redundant data to the transmitted information in order to detect and correct errors. A code rate indicates a ratio of the useful bits transmitted to a total number of bits transmitted. For instance, the code rate could be ½ (e.g., indicating half the bits are useful bits), ⅔ (e.g., indicating two thirds of the bits are useful), and¾ (e.g., indicating three quarter of the bits are useful bits) etc. In other examples, the code rate can refer to a ratio of information bits to redundant bits—e.g., a code rate of ⅔ can indicate for every three coded bits transmitted, two bits represent information and one bit represents a redundant parity bit used for the error detection and correction.

An MCS index is a combination of the modulation scheme and code rate to form a single parameter that determines a data rate and the robustness of the transmission. MCS selection and/or assignment is performed based on a channel condition, wherein a system selects and appropriates the MCS index aiming to maximize throughput while maintaining an acceptable error rate. In some examples, a low density parity check (LDPC) code word is a sequence of bits generated after applying LDPC encoding over a block of data. LDPC codes are error correcting codes, used in detecting and correcting errors.

In some examples, the MCS can be equal and in other examples the MCS can be unequal. In some examples, when the MCS is equal, a same MCS index is assigned across all the spatial streams of a user. That is, the MCS index per user remains the same for all spatial streams. In other examples, when there is unequal MCS (UEQ-MCS), spatial streams per user have different modulations as well as coding rates. Currently, the MCS index assignment for a user is based on its (e.g., the user's) worst spatial stream (e.g., the same MCS index is used for all spatial streams). The difference in the MCS index across spatial streams per user needs to be restricted to reduce the complexity of the UEQ-MCS.

Currently for a same/equal modulation coding scheme (MCS), the MCS index is assigned for all spatial streams per user. For multiple users (e.g., for a Multiple Input Multiple Output (MIMO) system), a different/unequal MCS may be assigned to different users. However, per user, the MCS remains the same for all spatial streams. The same number of bits in a low-density parity-check (LDPC) codeword are transmitted on different spatial streams of the user. In some examples, the MCS index assignment for a user is based on the worst spatial stream, causing the same MCS index for all spatial streams. Accordingly, a signal to noise ratio (SNR) imbalance may occur over spatial streams of a user. That is, assignment of the same/equal MCS for all spital streams is suboptimal due to the variation of channel quality across the spatial streams.

In some cases, using spatial stream quality dependent MCS indexes for different streams of a user can cause enhanced throughput and better reliability. Hence, the unequal MCSs can be assigned to different spatial streams to adapt the SNR conditions for higher throughput.

In task group 802.11bn, unequal (UEQ)-MCS is being discussed where each spatial stream of the user can be assigned a different MCS. The spatial streams have varying modulation coding schemes (MCSs). The LDPC encoding and decoding may operate individually on different spatial streams of the user. All the spatial streams may have different code or be independently coded. The UEQ-MCS in a frequency domain is suitable for interference environment, as the interference in a resource unit (RU) does not affect the other Rus. That is, due to the use of independent encoders across RUs, there is low interference. By using the UEQ-MCS, different levels of protection can be provided to the frames of different importance due to the use of independent coding. That is, the UEQ-MCS can enable spatial streams to have different modulations and as well as coding rates across the spatial streams and across the RUs.

The UEQ-MCS has more freedom on coding rates of spatial streams compared to unequal modulation (UEQM). In some examples, strong spatial streams transmit a greater number of bits in LDPC codewords compared to weak spatial streams. The spatial stream with the lowest signal-to-noise ratio (SNR) is considered as the worst spatial stream whereas the spatial stream with the highest SNR is considered as the best spatial stream. That is, currently a SNR imbalance may occur over spatial streams of a user due to the variations of channel quality, the assignment of the same or equal MCS for all spatial streams is suboptimal due to the variation of channel quality across the spatial streams, and there is no process for assigning UEQ-MCS.

None of the existing state of the art discussed the ways for the assignment of UEQ-MCS to multiple spatial streams. Hence, there is a need in the art for solutions which will overcome the above-mentioned drawback(s), among others.

### SUMMARY

The disclosure provides methods and systems for methods and systems for assigning an unequal modulation and coding scheme (MCS) in a wireless local area network (WLAN).

The disclosure provides methods and systems for determining a number of spatial streams associated with a user and a maximum difference in a MCS index allowed across different spatial streams per user.

The disclosure provides methods and systems for determining a type of unequal MCS to be enabled at the user equipment (UE).

The disclosure provides methods and systems for identifying a primary spatial stream based on the type of unequal MCS to be enabled at the UE.

The disclosure provides methods and systems for enabling assignment of at least one MCS index to all the spatial streams based on at least one of the number of spatial streams (NSS), the maximum difference in the MCS index allowed across different spatial streams per user, the type of unequal MCS to be enabled at the UE and the identification of the primary spatial stream.

The disclosure provides methods and systems for performing MCS assignment in unequal MCS, wherein the MCS assignment is performed based on the worst spatial stream.

The disclosure provides methods and systems for performing MCS assignment in unequal MCS, wherein the MCS assignment is performed based on the best spatial stream.

The disclosure provides methods and systems for performing MCS assignment in unequal MCS, wherein the MCS assignment is performed based on the median spatial stream.

The disclosure provides methods to enable unequal MCS for different spatial streams of a user such that the MCS index of all the spatial streams are bound by a maximum difference.

One aspect of the present disclosure provides a user equipment (UE). The UE includes at least one controller including processing circuitry. The UE includes memory storing instructions that, when executed by the at least one controller individually or collectively, cause the UE to determine a maximum difference in an MCS index allowed across different spatial streams per user. The instructions, when executed by the at least one controller individually or collectively, cause the UE to determine a type of unequal MCS enabled at the UE. The instructions, when executed by the at least one controller individually or collectively, cause the UE to identify a primary spatial stream, based on the type of unequal MCS enabled at the UE. The instructions, when executed by the at least one controller individually or collectively, cause the UE to enable assignment of at least one MCS index to all the spatial streams based on at least one of the maximum difference in the MCS index allowed across different spatial streams per user, the type of unequal MCS enabled at the UE, or the identification of the primary spatial stream.

In some examples, the type of unequal MCS enabled at the UE comprises at least one of a first type of unequal MCS, a second type of unequal MCS, or a third type of unequal MCS.

In some examples, the first type of unequal MCS corresponds to unequal MCS assignment based on a worst spatial stream. The second type of unequal MCS corresponds to unequal MCS assignment based on a median spatial stream. The third type of unequal MCS corresponds to unequal MCS assignment based on a best spatial stream. A first spatial stream of all the spatial streams with a lowest Signal-to-Noise Ratio (SNR) is the worst spatial stream. A second spatial stream of all the spatial streams with a median SNR is the median spatial stream. A third spatial stream of all the spatial streams with a best SNR is the best spatial stream.

In some examples, to identify the primary spatial stream, the instructions, when executed by the at least one controller individually or collectively, cause the UE to perform identifying a worst spatial stream based at least in part on determining that a first type of unequal MCS is enabled. In some examples, to identify the primary spatial stream, the instructions, when executed by the at least one controller individually or collectively, cause the UE to perform identifying a median spatial stream based at least in part on determining that a second type of unequal MCS is enabled. In some examples, to identify the primary spatial stream, the instructions, when executed by the at least one controller individually or collectively, cause the UE to perform identifying a best spatial stream based at least in part on determining that a third type of unequal MCS is enabled.

In some examples, to enable the assignment of unequal MCS to all spatial stream per user, the instructions, when executed by the at least one controller individually or collectively, cause the UE to determine a first type of the unequal MCS is enabled. The instructions, when executed by the at least one controller individually or collectively, cause the UE to assign a minimum MCS index to the primary spatial stream based at least in part on determining the first type of the unequal MCS. In some examples, to enable the assignment of unequal MCS to all spatial stream per user, the instructions, when executed by the at least one controller individually or collectively, cause the UE to assign an MCS index for remaining spatial streams in a range from the minimum MCS index to a combination of the minimum MCS index and the maximum difference in MCS index allowed across the different spatial streams.

In some examples, to assign the MCS index for the remaining spatial streams, the instructions, when executed by the at least one controller individually or collectively, cause the UE to compute a subtraction of the minimum MCS index from an MCS index associated with an MCS corresponding to an obtained Signal-to-Noise Ratio (SNR) of a predefined spatial stream. To assign the MCS index for the remaining spatial streams, the instructions, when executed by the at least one controller individually or collectively, cause the UE to determine whether the computed subtraction of the minimum MCS from the MCS index associated with the MCS corresponding to the obtained SNR of the predefined spatial stream is less than or equal to the maximum difference in the MCS index allowed across the different spatial streams. To assign the MCS index for the remaining spatial streams, the instructions, when executed by the at least one controller individually or collectively, cause the UE to assign the MCS index with the MCS corresponding to the obtained SNR of the predefined spatial stream in response to determining that the computed subtraction of the minimum MCS index from the MCS index associated with the MCS corresponding to the obtained SNR of the predefined spatial stream is less than or equal to the maximum difference in the MCS index allowed across different spatial streams. To assign the MCS index for the remaining spatial streams, the instructions, when executed by the at least one controller individually or collectively, cause the UE to assign the MCS index with the sum of the minimum MCS index and the maximum difference in the MCS index allowed in response to determining that the computed subtraction of the minimum MCS index from the MCS index associated with the MCS corresponding to the obtained SNR of the predefined spatial stream is not less than or equal to the maximum difference in the MCS index allowed across the different spatial streams.

In some examples, to enable assignment of unequal MCS to all spatial stream per user, the instructions, when executed by the at least one controller individually or collectively, cause the UE to determine a third type of the unequal MCS is enabled. The instructions, when executed by the at least one controller individually or collectively, cause the UE to assign a highest MCS index to the primary spatial stream. The instructions, when executed by the at least one controller individually or collectively, cause the UE to assign an MCS index for remaining spatial streams in a range from the highest MCS to a difference between the maximum difference in the MCS index allowed across the spatial streams and the highest MCS index.

In some examples, to assign the MCS index for the remaining spatial streams, the instructions, when executed by the at least one controller individually or collectively, cause the UE to compute a subtraction of an MCS index corresponding to an obtained Signal-to-Noise Ratio (SNR) of a predefined spatial stream from the highest MCS index. The instructions, when executed by the at least one controller individually or collectively, cause the UE to determine whether the computed subtraction is less than or equal to the maximum difference in MCS index allowed across the spatial streams. The instructions, when executed by the at least one controller individually or collectively, cause the UE to assign the MCS index with the MCS index corresponding to the obtained SNR of the predefined spatial stream based at least in part on determining that the computed subtraction is less than or equal to the maximum difference in the MCS index allowed across the spatial streams. The instructions, when executed by the at least one controller individually or collectively, cause the UE to assign the MCS index with the difference between the maximum difference in the MCS index allowed across the spatial streams and the highest MCS index based at least in part on determining that the computed subtraction is not less than or equal to the maximum difference in the MCS index allowed across the spatial streams.

In some examples, to enable assignment of unequal MCS to all spatial stream per user, the instructions, when executed by the at least one controller individually or collectively, cause the UE to determine a second type of the unequal MCS is enabled. The instructions, when executed by the at least one controller individually or collectively, cause the UE to assign a median MCS index to the primary spatial stream. The instructions, when executed by the at least one controller individually or collectively, cause the UE to determine whether the remaining spatial streams are better than a spatial stream associated with the second type of the unequal MCS. The instructions, when executed by the at least one controller individually or collectively, cause the UE to assign an MCS index for the remaining spatial streams in a first range from the median MCS index to a combination of the median MCS index and the maximum difference in the MCS index allowed divided by two in response to determining that the remaining spatial streams are better than the spatial stream associated with the second type of unequal MCS. The instructions, when executed by the at least one controller individually or collectively, cause the UE to assign the MCS index for the remaining spatial streams in a second range from a difference between the median MCS index and the maximum difference in the MCS index allowed divided by two to the median MCS index in response to determining that the remaining spatial streams are not better than spatial stream associated with the second type of unequal MCS.

In some examples, the instructions, when executed by the at least one controller individually or collectively, cause the UE to compute a subtraction of an MCS corresponding to an Signal-to-Noise Ratio (SNR) of a predefined spatial stream from the median MCS index. The instructions, when executed by the at least one controller individually or collectively, cause the UE to determine whether the computed subtraction of the MCS corresponding to the obtained SNR of the predefined spatial stream from the median MCS index is less than or equal to the maximum difference in the MCS index allowed across different spatial stream divided by two. The instructions, when executed by the at least one controller individually or collectively, cause the UE to assign the MCS index with the maximum difference in the MCS index allowed across different spatial stream divided by two subtracted from the median MCS index in response to determining that the computed subtraction is not less than or equal to the maximum difference in the MCS index allowed across different spatial stream divided by two and the MCS corresponding to the obtained SNR of the predefined spatial stream is less than the median MCS index. Or, the instructions, when executed by the at least one controller individually or collectively, cause the UE to assign the MCS index with a sum of the MCS median index and the maximum difference in the MCS index allowed across different spatial stream divided by two in response to determining that the computed subtraction is not less than or equal to the maximum difference in the MCS index allowed across different spatial stream divided by two and the MCS corresponding to the obtained SNR of the predefined spatial stream is greater than the median MCS index. Or, the instructions, when executed by the at least one controller individually or collectively, cause the UE to assign the MCS index with the MCS corresponding to the obtained SNR of the predefined spatial stream in response to determining that an absolute value of the computed subtraction is less than or equal to the maximum difference in the MCS index allowed across different spatial stream divided by two.

In some examples, the instructions, when executed by the at least one controller individually or collectively, cause the UE to determine, by the UE, a number of spatial streams (NSS) per UE associated with a user, wherein enabling the assignment of the at least one MCS index is based at least in part on the NSS.

One aspect of the present disclosure provides a method for assigning an unequal modulation and coding scheme (MCS) in a wireless network. The method includes determining, by a user equipment (UE), a maximum difference in an MCS index allowed across different spatial streams per user. The method includes determining, by the UE, a type of unequal MCS enabled at the UE. The method includes identifying, by the UE, a primary spatial stream, based on the type of unequal MCS enabled at the UE. The method includes enabling, by the UE, the assignment of the at least one MCS index to all the spatial streams based on at least one of the maximum difference in the MCS index allowed across different spatial streams per user, the type of unequal MCS enabled at the User Equipment, or the identification of the primary spatial stream.

In some examples, the type of unequal MCS enabled at the UE comprises at least one of a first type of unequal MCS, a second type of unequal MCS, or a third type of unequal MCS.

In some examples, the first type of unequal MCS corresponds to unequal MCS assignment based on a worst spatial stream. The second type of unequal MCS corresponds to unequal MCS assignment based on a median spatial stream. The third type of unequal MCS corresponds to unequal MCS assignment based on a best spatial stream. A first spatial stream of all the spatial streams with a lowest Signal-to-Noise Ratio (SNR) is the worst spatial stream. A second spatial stream of all the spatial streams with a median SNR is the median spatial stream. A third spatial stream of all the spatial streams with a best SNR is the best spatial stream.

In some examples, the identifying of the primary spatial stream includes performing one of: (1) identifying a worst spatial stream based at least in part on determining that a first type of unequal MCS is enabled, (2) identifying a median spatial stream based at least in part on determining that a second type of unequal MCS is enabled, or (3) identifying a best spatial stream based at least in part on determining that a third type of unequal MCS is enabled.

In some examples, the enabling of the assignment of unequal MCS to all spatial stream per user includes determining a first type of the unequal MCS is enabled. The enabling of the assignment of unequal MCS to all spatial stream per user includes assigning a minimum MCS index to the primary spatial stream based at least in part on determining the first type of the unequal MCS. The enabling of the assignment of unequal MCS to all spatial stream per user includes assigning an MCS index for remaining spatial streams in a range from the minimum MCS index to a combination of the minimum MCS index and the maximum difference in MCS index allowed across the different spatial streams.

In some examples, the assigning of the MCS index for the remaining spatial streams includes computing a subtraction of the minimum MCS index from an MCS index associated with an MCS corresponding to an obtained Signal-to-Noise Ratio (SNR) of a predefined spatial stream. The assigning of the MCS index for the remaining spatial streams includes determining whether the computed subtraction of the minimum MCS from the MCS index associated with the MCS corresponding to the obtained SNR of the predefined spatial stream is less than or equal to the maximum difference in the MCS index allowed across the different spatial streams. The assigning of the MCS index for the remaining spatial streams includes one of: (1) assigning the MCS index with the MCS corresponding to the obtained SNR of the predefined spatial stream in response to determining that the computed subtraction of the minimum MCS index from the MCS index associated with the MCS corresponding to the obtained SNR of the predefined spatial stream is less than or equal to the maximum difference in the MCS index allowed across different spatial streams, or (2) assigning the MCS index with the sum of the minimum MCS index and the maximum difference in the MCS index allowed in response to determining that the computed subtraction of the minimum MCS index from the MCS index associated with the MCS corresponding to the obtained SNR of the predefined spatial stream is not less than or equal to the maximum difference in the MCS index allowed across the different spatial streams.

In some examples, the enabling of assignment of unequal MCS to all spatial stream per user includes determining a third type of the unequal MCS is enabled. The enabling of assignment of unequal MCS to all spatial stream per user includes assigning a highest MCS index to the primary spatial stream. The enabling of assignment of unequal MCS to all spatial stream per user includes assigning an MCS index for remaining spatial streams in a range from the highest MCS to a difference between the maximum difference in the MCS index allowed across the spatial streams and the highest MCS index.

In some examples, the assigning of the MCS index for the remaining spatial streams includes computing a subtraction of an MCS index corresponding to an obtained Signal-to-Noise Ratio (SNR) of a predefined spatial stream from the highest MCS index. The assigning of the MCS index for the remaining spatial streams includes determining whether the computed subtraction is less than or equal to the maximum difference in MCS index allowed across the spatial streams. The assigning of the MCS index for the remaining spatial streams includes performing one of: (1) assigning the MCS index with the MCS index corresponding to the obtained SNR of the predefined spatial stream based at least in part on determining that the computed subtraction is less than or equal to the maximum difference in the MCS index allowed across the spatial streams, or (2) assigning the MCS index with the difference between the maximum difference in the MCS index allowed across the spatial streams and the highest MCS index based at least in part on determining that the computed subtraction is not less than or equal to the maximum difference in the MCS index allowed across the spatial streams.

In some examples, the enabling of assignment of unequal MCS to all spatial stream per user includes determining a second type of the unequal MCS is enabled. The enabling of assignment of unequal MCS to all spatial stream per user includes assigning a median MCS index to the primary spatial stream. The enabling of assignment of unequal MCS to all spatial stream per user includes determining whether the remaining spatial streams are better than a spatial stream associated with the second type of the unequal MCS. The enabling of assignment of unequal MCS to all spatial stream per user includes performing one of: (1) assigning an MCS index for the remaining spatial streams in a first range from the median MCS index to a combination of the median MCS index and the maximum difference in the MCS index allowed divided by two in response to determining that the remaining spatial streams are better than the spatial stream associated with the second type of unequal MCS, or (2) assigning the MCS index for the remaining spatial streams in a second range from a difference between the median MCS index and the maximum difference in the MCS index allowed divided by two to the median MCS index in response to determining that the remaining spatial streams are not better than spatial stream associated with the second type of unequal MCS.

In some examples, the method includes computing a subtraction of an MCS corresponding to an Signal-to-Noise Ratio (SNR) of a predefined spatial stream from the median MCS index. The method includes determining whether the computed subtraction of the MCS corresponding to the obtained SNR of the predefined spatial stream from the median MCS index is less than or equal to the maximum difference in the MCS index allowed across different spatial stream divided by two. The method includes performing one of: (1) assigning the MCS index with the maximum difference in the MCS index allowed across different spatial stream divided by two subtracted from the median MCS index in response to determining that the computed subtraction is not less than or equal to the maximum difference in the MCS index allowed across different spatial stream divided by two and the MCS corresponding to the obtained SNR of the predefined spatial stream is less than the median MCS index, (2) assigning the MCS index with a sum of the MCS median index and the maximum difference in the MCS index allowed across different spatial stream divided by two in response to determining that the computed subtraction is not less than or equal to the maximum difference in the MCS index allowed across different spatial stream divided by two and the MCS corresponding to the obtained SNR of the predefined spatial stream is greater than the median MCS index, or (3) assigning the MCS index with the MCS corresponding to the obtained SNR of the predefined spatial stream in response to determining that an absolute value of the computed subtraction is less than or equal to the maximum difference in the MCS index allowed across different spatial stream divided by two.

In some examples, the method includes determining, by the UE, a number of spatial streams (NSS) per UE associated with a user, wherein enabling the assignment of the at least one MCS index is based at least in part on the NSS.

One aspect of the present disclosure provides a non-transitory computer-readable storage medium. The methods disclosed herein can be performed by one or more computer programs stored on the non-transitory computer-readable storage medium

In some examples, the non-transitory computer-readable storage medium stores one or more computer programs, when executed by at least one controller individually or collectively, cause a user equipment (UE) to determine a maximum difference in an MCS index allowed across different spatial streams per user. The one or more computer programs, when executed by at least one controller individually or collectively, further cause the UE to determine a type of unequal MCS enabled at the UE. The one or more computer programs, when executed by at least one controller individually or collectively, further cause the UE to identify a primary spatial stream, based on the type of unequal MCS enabled at the UE. The one or more computer programs, when executed by at least one controller individually or collectively, further cause the UE to enable the assignment of the at least one MCS index to all the spatial streams based on at least one of the maximum difference in the MCS index allowed across different spatial streams per user, the type of unequal MCS enabled at the User Equipment, or the identification of the primary spatial stream.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustrations and drawings. Embodiments herein are illustrated by way of examples in the accompanying drawings, and in which:

FIG. 1 shows various hardware components of a user equipment (UE, for assigning an unequal modulation and coding scheme (MCS) in a wireless local area network (WLAN), according to an embodiment;

FIG. 2 is an example flow diagram for assigning the unequal MCS in the wireless local area network (LAN), according to an embodiment;

FIG. 3 is an example flow diagram for assigning the MCS based on a worst spatial stream, according to an embodiment;

FIG. 4 is an example flow diagram for assigning the MCS based on a best spatial stream, according to an embodiment;

FIG. 5 is an example flow diagram for assigning the MCS based on a median spatial stream, according to an embodiment;

FIG. 6 is an example chart depicting a method for assigning an unequal MCS in the wireless LAN, according to an embodiment;

FIG. 7 is an example table for assigning a MCS index, according to an embodiment;

FIG. 8 is an example table for performing possible MCS assignment for two spatial streams, when spatial stream one is the best spatial stream, according to an embodiment;

FIG. 9 is an example table for performing possible MCS assignment for two spatial streams, when spatial stream one is the worst spatial stream, according to an embodiment;

FIG. 10 is an example table for performing possible MCS assignment for three spatial streams, when spatial stream one is the best spatial stream, according to embodiment as disclosed herein;

FIG. 11 is an example table for performing possible MCS assignment for three spatial streams, when spatial stream one is the worst spatial stream, according to an embodiment;

FIG. 12 is an example table for performing possible MCS assignment for three spatial streams, when spatial stream one is the best spatial stream, according to an embodiment; and

FIG. 13 is an example table for performing possible MCS assignment for three spatial streams, when spatial stream one is the worst spatial stream, according to an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

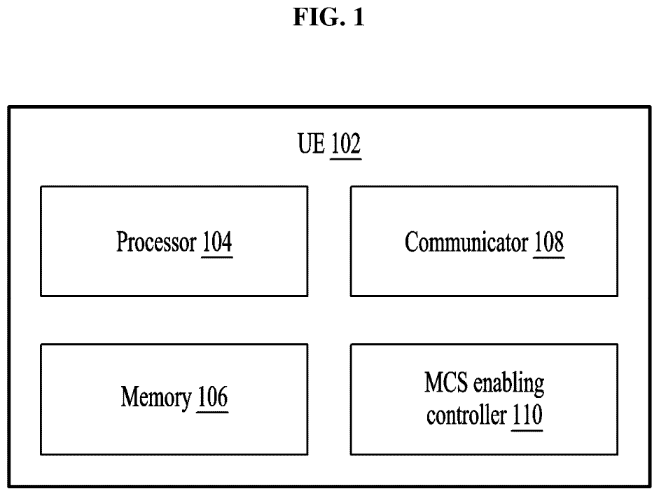

Referring now to the drawings, and more particularly to FIGS. 1 through 6, where similar reference characters denote corresponding features consistently throughout the figures, when the reference characters are shown in an embodiment.

Embodiments herein disclose methods and systems for assigning an unequal modulation and coding scheme (MCS) in a wireless local area network (WLAN). The proposed method allows a user equipment (UE) to determine a number of spatial streams (NSS) per UE associated with a user. The UE determines a maximum difference in a MCS index allowed across different spatial streams per user (e.g., assume different MCS). The UE identifies a primary spatial stream, based on the type of unequal MCS to be enabled at the UE. The UE enables assignment of the at least one MCS index to all the spatial streams based on at least one of the NSS, the maximum difference in the MCS index allowed across different spatial streams per user, the type of unequal MCS to be enabled at the UE and the identification of the primary spatial stream. Thus, resulting in improving the efficient utilization of spectrum and channel conditions.

The spatial stream of a user with the lowest signal-to-noise ratio (SNR) is considered as the worst spatial stream and spatial stream of a user with the highest SNR is considered as the best spatial stream. The spatial stream with the medium SNR is considered as the median spatial stream.

The proposed method provides an efficient approach for the MCS assignment across the spatial streams of the user, to enable unequal MCS (UEQ-MCS). That is, different MCS for different spatial streams of a user with higher throughput/reliability. This results in improving channel utilization and performance.

The proposed embodiment enables the UEQ-MCS and takes advantage of variations in the channel condition. Thus, resulting in achieving higher throughput and reliability, to enable more freedom on coding rates of spatial streams. Different levels of protection can be provided to the frames of different importance due to the use of independent coding. Accordingly, the embodiment described herein is suitable for interference environments and takes advantage of variations in the channel condition. Unequal MCS helps with efficient utilization of channels (for all spatial streams of a user) and improves throughput and reliability.

FIG. 1 shows various hardware components of a user equipment (UE) (102), for assigning an unequal modulation and coding scheme (MCS) in a wireless local area network (WLAN). UE 102 may interact with the WLAN to enable unequal MCS. The UE 102 referred to herein may be an electronic device/user device that is used by the user to connect, interact, and/or control the operations of the plurality of other devices using a 3GPP network or non-3GPP network. Examples of the UE 102 may include, but are not limited to, a smartphone, a mobile phone, a video phone, a computer, a tablet personal computer (PC), a laptop, a wearable device, television, a personal digital assistant (PDA), an internet of things (IoT) device, Wi-Fi device, or any other device that may use a 3GPP network or non-3GPP network.

In some examples, the UE 102 can determine a number of spatial streams (NSS) per UE 102 associated with a user. In some examples, the UE 102, on determining the NSS, may determine a maximum difference in the MCS index allowable across different spatial streams per user, referred to as parameter ‘diff_MCS’. The parameter diff_MCS sets the bounds for different the MCS levels that can be between the best and worst streams, so as to ensure that complexity and reliability are kept within acceptable limits. In some examples, the diff_MCS is either user defined or it is negotiated during setup.

Further, the UE 102 can select the type of unequal MCS to be enabled at the UE 102. For example, the UE 102 enables the assignment of unequal MCS index to all the spatial streams based on at least one of the NSS, the maximum difference in the MCS index allowed across different spatial streams per user, the type of unequal MCS to be enabled at the UE 102 and the identification of the primary spatial stream. In some examples, the maximum difference in the MCS index allowed across different streams is a difference between the best and worst spatial stream, wherein the MCS index with the best spatial stream (denoted as ‘M’) and the worst spatial stream (denoted as ‘N’) and the difference between the spatial streams ‘M’ and ‘N’ is bounded around the parameter diff_MCS. For an instance, if the best stream of the UE 102 supports the MCS index MCSₘ and the worst stream supports MCS index MCSₙ, then the maximum difference in the MCS index is MCSₘ−MCSₙ and the difference is bounded by the parameter diff_MCS. The parameter diff_MCS sets the bounds for different MCS levels that can be between the best and the worst streams, so as to ensure that complexity and reliability are kept within acceptable limits. In another example, if there are ‘N’ number of spatial streams per user, the spatial stream corresponding to the maximum channel gain is the best spatial stream. Likewise, the ‘N’ number of spatial streams per user, corresponding to the minimum channel gain the worst spatial stream.

In some examples, a type of unequal MCS to be enabled comprises at least one of a first type of unequal MCS, a second type of unequal MCS and a third type of unequal MCS. That is, the way to assign an MCS index to each spatial stream of the user may vary based on the type of unequal MCS. For example, the first type corresponds to unequal MCS assignment based on a worst spatial stream, the second type corresponds to unequal MCS assignment based on a median spatial stream, and the third type corresponds to unequal MCS assignment based on a best spatial stream. The spatial stream with a lowest Singl-to-Noise-Ratio (SNR) is the worst spatial stream, the spatial stream with a median SNR is the median spatial stream, and the spatial stream with a best SNR is the best spatial stream. For the first type, assignment is based on the suitable MCS index identified as the worst spatial stream. For the second type, assignment is based on the suitable MCS index identified as the median spatial stream. For the third type, assignment is based on the suitable MCS index identified as the best spatial stream.

In another instance, the streams are classified as the best, the worst, and the median spatial stream based on the SNR of the streams.

After determining the type of unequal MCS to be enabled at the UE 102, the UE 102 identifies the primary spatial stream accordingly. That is, the UE 102 identifies the worst spatial stream when the first type of unequal MCS is enabled. In such examples, the UE 102 can identify the worst spatial stream by choosing a stream with the lowest signal-to-noise ratio (SNR). In some examples, the UE 102 identifies the median spatial stream when the second type of unequal MCS is enabled. In such examples, the UE 102 can identify the median spatial stream by choosing a stream with the median SNR. In some examples, the UE 102 identifies the best spatial stream when the third type of unequal MCS is enabled. In an embodiment, the UE 102 can identify the best spatial stream by choosing a stream with the highest SNR.

Therefore, the UE 102 proceeds to assign unequal MCS indices to all spatial streams based on the selected primary spatial stream. In some examples, the assignment is performed based on the combination of the NSS, the maximum difference in the MCS index allowable across different spatial streams per user, the type of unequal MCS to be enabled at the UE 102 and identification of the primary spatial stream. Streams with better SNR may receive higher-order MCS, while those with weaker SNR are assigned more robust, lower-order MCS.

In an embodiment, the UE 102 comprises a processor 104, a memory 106, a communicator 108, and an MCS enabling controller 110. The processor 104 includes processing circuitry. In an embodiment, the MCS enabling controller 110 includes processing circuitry and may determine the NSS per user. The MCS enabling controller 110 may be configured to enable the assignment of the unequal MCS to all the spatial streams per user.

The processor 104 or the processing circuitry of the processor 104 may include one or a plurality of processors. The one or a plurality of processors may be a general-purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU).

The memory 106 referred herein include at least one type of storage medium, from among a flash memory type storage medium, a hard disk type storage medium, a multi-media card micro type storage medium, a card type memory (for example, an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

The controller 110 or the processing circuitry of the controller 110 may include one or a plurality of processors and/or controllers. The one or a plurality of controllers may be a general-purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU).

In an embodiment, the MCS enabling controller 110 determines that the first type of the unequal MCS is enabled. In an embodiment, the MCS enabling controller 110 assigns the minimum MCS index (MCSₘᵢₙ) to the primary spatial stream. The MCS enabling controller 110 assigns the MCS index for remaining spatial streams in a range from the minimum MCS index (MCSₘᵢₙ) to a combination of the minimum MCS index (MCSₘᵢₙ), and a predefined maximum MCS index difference across the different spatial streams.

In some examples, the MCS enabling controller 110 may determine the first type of the unequal MCS is enabled. In an embodiment, the MCS index (MCSₙ) assigned to the spatial stream is computed by a subtraction of the minimum MCS index (MCSₘᵢₙ) from the MCS index associated with the MCS corresponding to the obtained SNR of the spatial stream (SNRₙ). In an embodiment, MCS enabling controller 110 determines the computed subtraction of the minimum MCS (MCSₘᵢₙ) from the MCS index (MCSₙ) associated with the MCS corresponding to the obtained SNR of the spatial stream (SNRₙ) is lesser than and equal to the predefined maximum MCS index difference across the different spatial streams. In an embodiment, the MCS enabling controller 110 assigns the MCS index (MCSₙ) with the MCS corresponding to the obtained SNR of the spatial stream (SNRₙ) in response to determining that the computed subtraction of the minimum MCS index (MCSₘᵢₙ) from the MCS index associated with the MCS corresponding to the obtained SNR of the spatial stream (SNRₙ) is lesser than and equal to the maximum difference allowed in MCS index across different spatial streams.

In an embodiment, the MCS enabling controller 110 determines the computed subtraction of the minimum MCS index (MCSₘᵢₙ) from the MCS index associated with the MCS corresponding to the obtained SNR of the predefined spatial stream (SNRₙ) is not less than or equal to the predefined maximum MCS index difference across the different spatial streams. In an embodiment, the MCS enabling controller 110 assigns the MCS index (MCSₙ) with the sum of the minimum MCS index (MCSₘᵢₙ) and the predefined maximum MCS index difference.

In an embodiment, the MCS enabling controller 110 assigns the unequal MCS to all spatial streams per user and determines that the second type of unequal MCS is enabled. In an embodiment, the MCS enabling controller 110 assigns the median MCS index (MCS_{median}) to the primary spatial stream. In some examples, the MCS enabling controller 110 identifies whether the remaining spatial streams are better than the second type of the spatial stream.

In some examples, the MCS enabling controller 110 assigns the MCS index for the remaining spatial streams in the range of the median MCS index (MCS_{median}) to MCS_{median} along with the diff_MCS/2 in response to identifying the remaining spatial streams are better than the second type of the spatial stream. In some examples, the MCS enabling controller 110 assigns the MCS index for the remaining spatial streams in the range of computing subtraction of diff_MCS/2 from the median MCS index (MCS_{median}) to the MCS_{median} in response to identifying that the remaining spatial streams are not better than the second type of the spatial stream.

In an embodiment, the MCS enabling controller 110 identifies that the second type of unequal MCS is enabled, and the MCS index (MCSₙ) is assigned to the primary spatial stream. In an embodiment, the MCS enabling controller 110 computes the subtraction of the MCS corresponding to the SNR of the predefined spatial stream (SNRₙ) from the median MCS index (MCS_{median}).

In an embodiment, the MCS enabling controller 110 determines that the computed subtraction of the MCS corresponding to the obtained SNR of the predefined spatial stream (SNRₙ) from the median MCS index (MCS_{median}) is less than and equal to diff_MCS/2.

In some examples, the MCS enabling controller 110 assigns the MCS index (MCSₙ) with the diff_MCS/2 subtracted from the MCS_{median} in response to determining that the computed subtraction of the MCS corresponding to the SNR of the spatial stream (SNRₙ) from the median MCS index (MCS_{median}) is not less than or equal to diff_MCS/2 and the MCS corresponding to the obtained SNR of the predefined spatial stream (SNRₙ) is less than MCS_{median}.

In some examples, the MCS enabling controller 110 assigns the MCS index (MCSₙ) with sum of MCS_{median} along with the diff_MCS/2 in response to determining that the computed subtraction of the MCS corresponding to the obtained SNR of the predefined spatial stream (SNRₙ) from the median MCS index (MCS_{median}) is not less than and equal to diff_MCS/2 and MCS corresponding to the obtained SNR of the predefined spatial stream (SNRₙ) is greater than MCS_{median}.

In some examples, the MCS enabling controller 110 assigns the MCS index (MCSₙ) with the MCS corresponding to the obtained SNR of the predefined spatial stream (SNRₙ), in response to determining that the modulus of the computed subtraction is less than and equal to diff_MCS/2, wherein MCS provides MCS index used in the corresponding MCS index.

In some examples, the MCS enabling controller 110 assigns the unequal MCS to spatial streams per user and determines that the third type of unequal MCS is enabled. In an embodiment, the MCS enabling controller 110 assigns the highest MCS index (MCS_{highest}) to the primary spatial stream. The MCS enabling controller 110 assigns the MCS index for the remaining spatial streams in the range from the highest MCS (MCS_{highest}) to the predefined maximum MCS index difference across the spatial streams subtracted from the MCS_{highest}.

In some examples, the MCS enabling controller 110 determines the third type of unequal MCS is enabled. In an embodiment, the MCS index (MCSₙ) is assigned to the primary spatial stream by computing a subtraction of the MCS index (MCS) corresponding to the obtained SNR associated with the n^{th} spatial stream (SNRₙ) from the highest MCS index (MCS_{highest}).

In some examples, the MCS enabling controller 110 determines whether the computed subtraction is less than and equal to the predefined maximum MCS index difference across the spatial streams. For example, the MCS enabling controller 110 performs assigning the MCS index (MCSₙ) with the MCS index corresponding to the obtained SNR of the predefined spatial stream (SNRₙ) on determining that the computed subtraction is less than and equal to the predefined maximum MCS difference (diff_MCS) across the spatial streams. In some examples, the MCS enabling controller 110 assigns the MCS index (MCSₙ) with the predefined maximum MCS index difference across the spatial streams subtracted from the highest MCS index (MCS_{highest}) on determining that the computed subtraction is more than the predefined maximum MCS index difference (diff_MCS) across the spatial streams

The MCS enabling controller 110 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 104 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 104 may include multiple cores and is configured to execute the instructions stored in the memory 106.

Further, the processor 104 is configured to execute instructions stored in the memory 106 and to perform various processes. The communicator 108 is configured for communicating internally between internal hardware components and with external devices via one or more networks. The memory 106 also stores instructions to be executed by the processor 104. The memory 106 may include non-volatile storage elements such as magnetic hard discs, optical discs, floppy discs, flash memories, or forms of electrically programmable memories (EPROM) or electrically erasable and programmable (EEPROM) memories. In addition, the memory 106 may, in some examples, be considered a non-transitory storage medium. The term “non-transitory” may indicate that the storage medium is not embodied in a carrier wave or a propagated signal. However, the term “non-transitory” should not be interpreted that the memory 106 is non-movable. In certain examples, a non-transitory storage medium may store data that can, over time, change (e.g., in Random Access Memory (RAM) or cache).

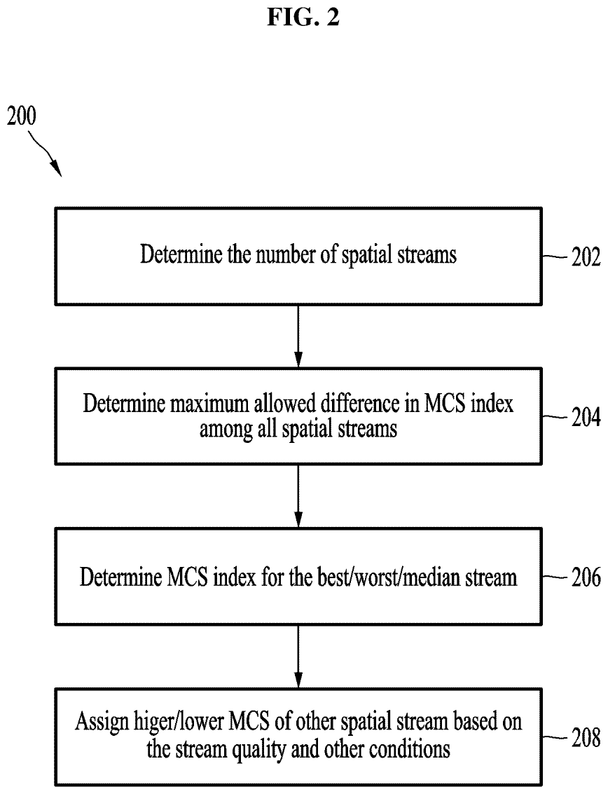

FIG. 2 is an example flow diagram 200 for assigning the unequal MCS in the wireless local area network (WLAN). The various actions in flow diagram 200 may be performed in the order presented, in a different order or simultaneously. Further, In some examples, some actions listed in FIG. 2 may be omitted. In some examples, the operations, actions, or blocks described herein are performed by a user equipment (e.g., UE 102 as described with reference to FIG. 1). In an embodiment, portions of the actions and operations described herein are performed by the MCS enabling controller 110.

As illustrated in block 202, the UE 102 determines a total number of spatial streams (NSS) per UE associated with a user.

In block 204, the UE 102 determines a maximum difference in an MCS index allowed across different spatial streams per user.

In block 206, the UE 102 determines the type of unequal MCS to be enabled at the UE 102. In some examples, the spatial stream with the lowest SNR is the worst spatial stream, while the spatial stream with the highest SNR is the best spatial stream and spatial stream with the median SNR is the median spatial stream. The UE 102 determines the MCS index to be assigned for the corresponding spatial streams such as worst, best and the median spatial stream. For example, the first type of unequal MCS can correspond to the worst spatial stream, the second type of unequal MCS can correspond to the median spatial stream, and the third type of unequal MCS can correspond to the best spatial stream.

In block 208, the UE 102 assigns higher, lower and median MCS of other spatial stream based on the stream quality and other conditions. The UE 102 can assign MCS index to the spatial streams based on at least one of the NSS, the maximum difference in the MCS index allowed across different spatial streams per user, the type of unequal MCS to be enabled at the UE 102 and the identification of the primary spatial stream.

In an example, the UE 102 enables unequal MCS (UEQ-MCS). That is, the UE 102 enables different MCS for different spatial streams of the user. In a case of the worst spatial stream, the UE 102 determines the MCS index (MCSₘᵢₙ) for the worst spatial stream among all the spatial streams per user and the as per (SNR)-MCS mapping. In an embodiment, to NSS-1 spatial streams, the UE 102 assigns the MCS index from the subset of MCSₘᵢₙ to (MCSₘᵢₙ+diff_MCS).

In case of the best spatial stream, the UE 102 determines the MCS index (MCSₘₐₓ) for the best spatial stream among all the spatial streams per user and the as per the (SNR)-MCS mapping. In an embodiment, to all other NSS-1 spatial streams, the UE 102 assigns the MCS index from the subset of (MCSₘₐₓ−diff_MCS) to MCSₘₐₓ.

In case of the median spatial stream, the UE 102 determines the MCS index (MCS_{median}) for the median spatial stream among all the spatial streams per user and the as per the (SNR)-MCS mapping. The median spatial stream is a spatial stream with a condition between the best and worst spatial stream. To all other NSS-1 spatial streams, the UE 102 assigns the MCS if the spatial stream quality is better than the median spatial stream from the subset of MCS_{median} to (MCS_{median}+diff_MCS/2). If spatial stream quality is worse than median spatial stream, the UE 102 assigns the MCS from the subset of (MCS_{median}−diff_MCS/2) to MCS_{median}.

The proposed embodiment enables the UEQ-MCS and takes advantage of variations in the channel condition. Thereby, it helps in achieving higher throughput and reliability, to enable more freedom on coding rates of spatial streams. Different levels of protection can be provided to the frames of different importance due to the use of independent coding. The embodiments described herein are suitable for interference environments and take advantage of variations in the channel condition. Unequal MCS helps in efficient utilization of channels (for all spatial streams of a user) and improves throughput and reliability.

In an embodiment, the UE 102 can enable the UEQ-MCS for different spatial streams of the user. The UE 102 assigns the MCS index to each spatial stream of the user such that the MCS index of all the spatial streams are bound by a maximum difference of a parameter ‘diff_MCS’ which denotes the maximum difference in MCS index allowed across different spatial streams per user. The diff_MCS is either user defined or it can be negotiated during setup.

In an embodiment, the UE 102 assigns the MCS index to each spatial stream of the user based on the worst spatial stream. For example, the UE 102 can start with the spatial stream with the worst condition (e.g., MCSₘᵢₙ). In some examples, the UE 102 assigns the rest of the spatial streams in the range of MCSₘᵢₙ to MCSₘᵢₙ+diff_MCS. In an embodiment, for an n^{th} spatial stream, the UE 102 assigns an MCS n^{th} which is equal to MCS (SNR n^{th}), based on determining the MCS (SNR n^{th})−MCSₘᵢₙ≤diff_MCS. In some examples, for an n^{th} spatial stream, the UE 102 assigns an MCS n^{th} which is equal to MCSₘᵢₙ+diff_MCS, based on determining MCS (SNR n^{th})−MCSₘᵢₙ>diff_MCS, wherein MCS (SNR n^{th}) represents an MCS corresponding to the SNR of the n^{th} spatial stream.

In some examples, the UE 102 assigns the MCS index to each spatial stream of the user based on the best spatial stream. For example, the UE 102 can start with the spatial stream with the best condition (e.g., MCSₘₐₓ). In some examples, the UE 102 assigns the rest of the spatial streams in the range MCSₘₐₓ−diff_MCS to MCSₘₐₓ if MCSₘₐₓ−diff_MCS≥MCS 0. In some examples, for the n^{th} spatial stream, the UE 102 assigns an MCS n^{th} equal to MCS (SNR n^{th}) based on determining if MCSₘₐₓ−MCS (SNR n^{th})≤diff_MCS. In some examples, for an n^{th} spatial stream, the UE 102 assigns an MCS n^{th} equal to MCSₘₐₓ−diff_MCS, based on determining MCSₘₐₓ−MCS (SNR n^{th})>diff_MCS, wherein MCS (SNR n^{th}) represents an MCS corresponding to the SNR of the n^{th} spatial stream.

In some examples, the UE 102 assigns the MCS index to each spatial stream of the user based on the median spatial stream. For example, the UE 102 can start with or on the channel with the median condition (e.g., MCS_{median}). In some examples, the UE 102 assigns the rest of the spatial streams in the range

$$M C {S}_{meidan} - \frac{diff\_MCS}{2} to M C {S}_{median} + \frac{diff\_MCS}{2} .$$

For example, for the n^{th} spatial stream, the UE 102 assigns MCS n^{th} equal to MCS (SNR n^{th}), based on determining that

$$- \frac{diff\_MCS}{2} \leq M C S ( S N R {n}^{th} ) - M C {S}_{median} \leq \frac{diff\_MCS}{2} .$$

Accordingly, the UE 102 assigns the MCS n^{th} equal to

$$M C {S}_{me dian} - \frac{diff\_MCS}{2} if M C S ( S N R {n}^{th} ) - M C {S}_{median} \leq \frac{diff\_MCS}{2}$$

and assigns the MCS n^{th} equal to

$$M C {S}_{median} + \frac{diff\_MCS}{2} if M C S ( S N R {n}^{th} ) - M C {S}_{median} > \frac{diff\_MCS}{2} .$$

Accordingly, as described herein, each spatial streams of a user may have different SNR. By matching MCS to SNR, a higher throughput is obtained. In UEQ-MCS systems, different MCS index are assigned for the different spatial streams to take advantage of spatial stream selective gains. In an embodiment, the diff_MCS parameter is the maximum allowed difference in a MCS index across different spatial streams per user. For example, the index MCS 0 associated with BPSK, 1/2), MCS 1 associated with QPSK, 1/2, MCS 2 associated with QPSK, 3/4, MCS 3 associated with 16 QAM, 1/2, MCS 4 associated with 16 QAM, 3/4, MCS 6 associated with 64 QAM, 2/3, MCS 7 associated with 64 QAM, 3/4, . . . , MCS12 associated with 4096 QAM, 3/4, and MCS 13 associated with 4096 QAM, 4/5, wherein dif_MCS=MCSₘₐₓ−MCSₘᵢₙ. It should be noted that the term ‘BPSK’ refers to Binary Phase Shift Keying, the term ‘QPSK’ refers to Quadrature Phase Shift Keying, and the term ‘QAM’ refers to Quadrature Amplitude Modulation.

In an embodiment, the encoding and decoding operates individually on different spatial streams of a user. That is, all the spatial streams may have different codes or be independently coded. Additionally, the value of diff_MCS is not theoretically limited. But limiting the diff_MCS value may reduce complexity.

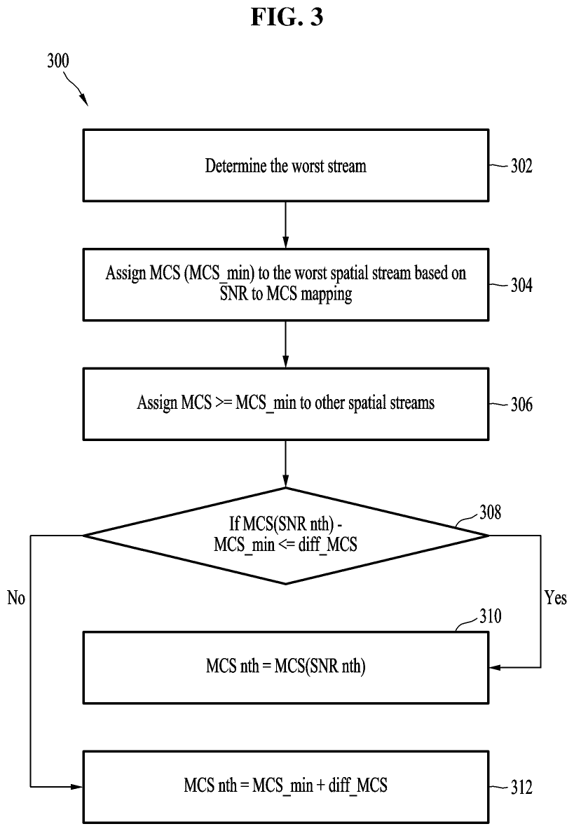

FIG. 3 is an example flow diagram 300 for assigning the MCS based on the worst spatial stream. The various actions in flow diagram 300 may be performed in the order presented, in a different order or simultaneously. Further, In some examples, some actions listed in FIG. 3 may be omitted. In some examples, the operations, actions, or blocks described herein are performed by a user equipment (e.g., UE 102 as described with reference to FIG. 1). In an embodiment, portions of the actions and operations described herein are performed by the MCS enabling controller 110.

As illustrated in block 302, the UE 102 determines the worst stream.

In block 304, the UE 102 assigns the MCS index for the worst spatial stream (detected using sounding), denoted by MCSₘᵢₙ. In an embodiment, the UE can assign the MCS index to the worst spatial stream using a Channel Quality Indicator (CQI) or SNR to MCS map as defined in IEEE 802.11 so far. In an embodiment, a higher MCS index is used for the remaining better spatial stream (based on sounding SNR).

In block 306, the UE 102 assigns higher/same MCS index for remaining spatial streams, e.g., MCS≥MCSₘᵢₙ. For example, the best spatial stream gets assigned with MCS<=MCSₘᵢₙ+diff_MCS. In an embodiment, since the worst spatial stream is assigned the minimum MCS, it reduces the combined Bit Error Rate and ensures a higher reliability.

In block 308, for an n^{th} spatial stream, the UE 102 determines whether the MCS (SNR n^{th})−MCSₘᵢₙ is less than or equal to diff_MCS. In an embodiment, the UE 102 proceeds to block 310 if MCS (SNR n^{th})−MCSₘᵢₙ is less than or equal to diff_MCS. In some examples, the UE 102 proceeds to 312 if MCS (SNR n^{th})−MCSₘᵢₙ is greater than diff_MCS.

In block 310, the UE 102 assigns MCS n^{th}=MCS (SNR n^{th}), based on identifying that the calculated MCS (SNR n^{th})−MCSₘᵢₙ is less than or equal to diff_MCS.

In block 312, the UE 102 assigns MCS n^{th}=MCSₘᵢₙ+diff_MCS, based on identifying that the calculated MCS (SNR n^{th})−MCSₘᵢₙ is not less than or equal to diff_MCS, wherein SNR n^{th} is the SNR corresponding to the n^{th} spatial stream.

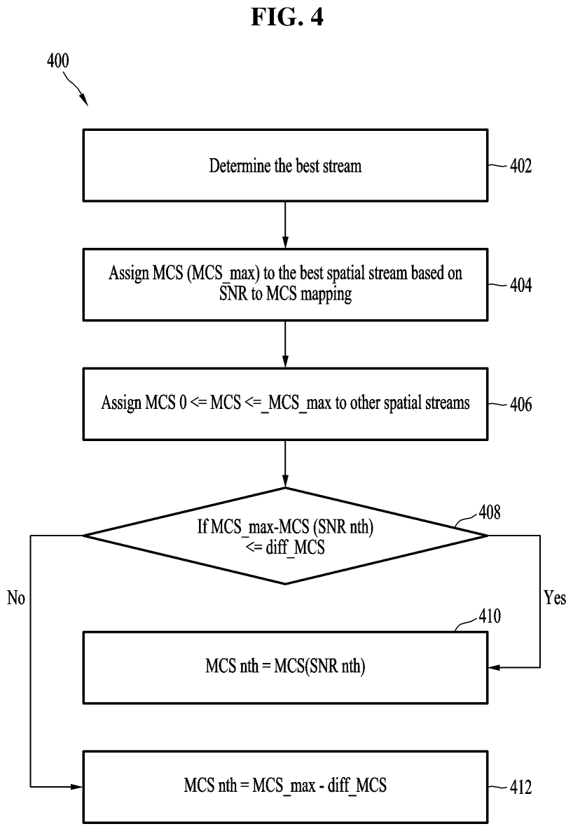

FIG. 4 is an example flow diagram 400 for assigning the MCS based on a best spatial stream. The various actions in flow diagram 400 may be performed in the order presented, in a different order or simultaneously. Further, In some examples, some actions listed in FIG. 4 may be omitted. In some examples, the operations, actions, or blocks described herein are performed by a user equipment (e.g., UE 102 as described with reference to FIG. 1). In an embodiment, portions of the actions and operations described herein are performed by the MCS enabling controller 110.

As illustrated in block S402, the UE 102 determines the best stream.

In block S404, the UE 102 assigns the MCS for the best spatial stream (detected using sounding), denoted by MCSₘₐₓ. In an embodiment, the UE 102 can use a reduced MCS index for the worse spatial stream (based on sounding SNR)—e.g., use a reduced MCS index for the remaining worse spatial streams.

In block S406, the UE 102 assigns a lower/same MCS for remaining spatial streams (e.g., MCS≤MCSₘₐₓ). For example, the worst spatial stream gets assigned with MCS≥MCSₘₐₓ−diff_MCS if MCSₘₐₓ−diff_MCS≥MCS 0 otherwise MCS=MCS 0. Since best spatial stream is assigned the highest MCS, there is higher spectral efficiency/throughput.

In block S408, for an n^{th} spatial stream, the UE 102 determines if MCSₘₐₓ−MCS (SNR n^{th})≤diff_MCS. For example, for the n^{th} spatial stream, the UE 102 calculates, MCSₘₐₓ−MCS of the n^{th} SNR (e.g., SNR n^{th}). The UE 102 then determines whether the calculated MCSₘₐₓ−MCS of the n^{th} SNR is less than or equal to diff_MCS. In an embodiment, the UE 102 can proceed to block S410 if MCSₘₐₓ−MCS (SNR n^{th})≤diff_MCS. In some examples, the UE 102 can proceed to block S412 if MCSₘₐₓ−MCS (SNR n^{th})>diff_MCS.

In block S410, the UE 102 identifies that the calculated MCSₘₐₓ−MCS of the n^{th} SNR is less than or equal to diff_MCS, the UE 102 assigns MCS n^{th} with the MCS (SNR n^{th}).

In block S412, the UE 102 identifies that the calculated MCSₘₐₓ−MCS of the n^{th} SNR is not less than or equal to diff_MCS, the UE 102 assigns MCS n^{th} with the MCSₘₐₓ−diff_MCS

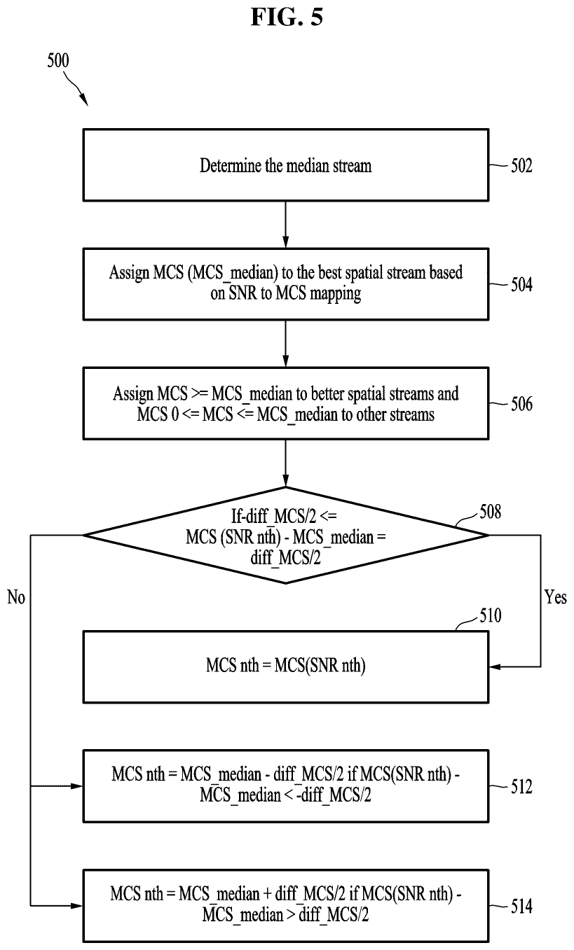

FIG. 5 is an example flow diagram 500 for assigning the MCS based on the median spatial stream. The various actions in flow diagram 500 may be performed in the order presented, in a different order or simultaneously. Further, In some examples, some actions listed in FIG. 5 may be omitted. In some examples, the operations, actions, or blocks described herein are performed by a user equipment (e.g., UE 102 as described with reference to FIG. 1). In an embodiment, portions of the actions and operations described herein are performed by the MCS enabling controller 110

In block 502, the UE 102 determines the median stream.

In block 504, the UE 102 assigns the MCS for the median spatial stream (detected using sounding) denoted by MCS_{median}, where MCS_{median} belongs to a set MCS 0 to MCS 13. In an embodiment, increased and decreased MCS levels are used depending on whether the spatial stream is better or lower (based on sounding SNR), respectively.

In block 506, the UE 102 assigns a higher/same MCSs for the remaining better spatial streams (e.g., MCS≥MCS_{median}) and

$$M C S \leq M C {S}_{median} + \frac{diff\_MCS}{2} .$$

Further, the UE 102 assigns a lower/same MCSs for the remaining worse spatial streams (e.g., MCS≤MCS_{median} and

$$M C S \geq M C {S}_{median} + \frac{diff\_MCS}{2} .$$

In block 508, for the n^{th} spatial stream, the UE 102 determines if

$$- \frac{{diff}_{MCS}}{2} \leq M C S ( S N R {n}^{th} ) - M C {S}_{median} = \frac{diff\_MCS}{2} ) .$$

In an embodiment, the UE 102 can proceed to block 510 if yes. In some examples, the UE 102 can proceed to block 512 if no.

In block 510, the UE 102 assigns MCS n^{th} with the MCS (SNR n^{th}) based on

$$- \frac{di {ff}_{MCS}}{2} \leq M C S ( S N R {n}^{th} ) - M C {S}_{median} = \frac{{diff}_{\_ MCS}}{2}$$

being true.

In block 512, the UE 102 assigns MCS n^{th} with the

$$M C {S}_{meidan} - \frac{diff\_MCS}{2} ,$$

based on identifying that the

$$M C S ( S N R {n}^{th} ) - M C {S}_{median} < - \frac{{diff}_{\_ MCS}}{2} .$$

In block 514, the UE 102 assigns MCS n^{th} with the

$$M C {S}_{meidan} + \frac{diff\_MCS}{2}$$

based on identifying that the

$$M C S ( S N R {n}^{th} ) - M C {S}_{median} > - \frac{{diff}_{\_ MCS}}{2} ,$$

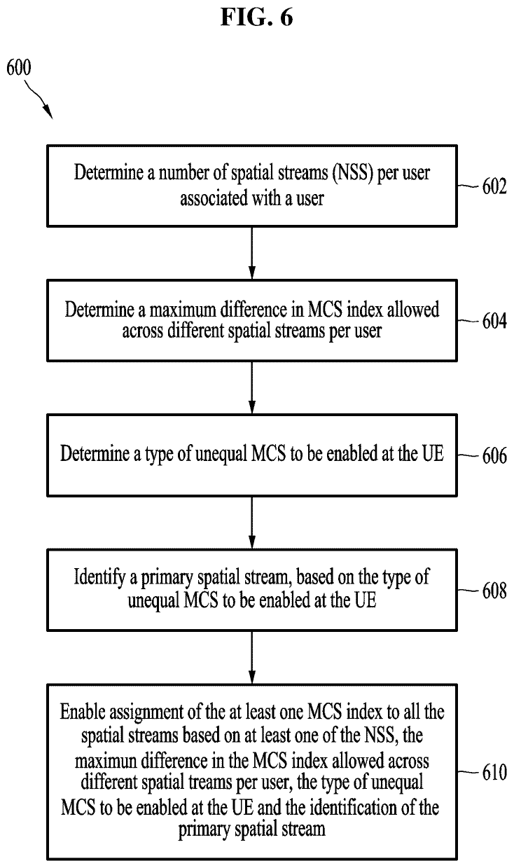

FIG. 6 is an example chart 600 depicting a method for assigning an unequal modulation and coding scheme (MCS) in the wireless local area network (WLAN). The various actions in flow diagram 600 may be performed in the order presented, in a different order or simultaneously. Further, In some examples, some actions listed in FIG. 6 may be omitted. In some examples, the operations, actions, or blocks described herein are performed by a user equipment (e.g., UE 102 as described with reference to FIG. 1).

As depicted in block 602, the UE 102 may determine a number of spatial streams (NSS) per UE associated with a user.

In block 604, the UE 102 may determine a maximum difference in a MCS index allowed across different spatial streams per user.

In block 606, the UE 102 may determine a type of unequal MCS enabled at the UE 102.

In block 608, the UE 102 may identify a primary spatial stream, based on the type of unequal MCS enabled at the UE.

In block 610, the UE 102 may enable assignment of the at least one MCS index to all the spatial streams based on at least one of the maximum difference in the MCS index allowed across different spatial streams per user, the type of unequal MCS enabled at the UE, or the identification of the primary spatial stream.

In an embodiment, the type of unequal MCS enabled includes at least one of a first type of unequal MCS, a second type of unequal MCS, or a third type of unequal MCS.

In some examples, the first type of unequal MCS corresponds to unequal MCS assignment based on a worst spatial stream, the second type of unequal MCS corresponds to unequal MCS assignment based on a medial spatial stream, and the third type of unequal MCS corresponds to unequal MCS assignment based on a best spatial stream, and wherein a first spatial stream of all the spatial streams with a lowest Signal-to-Noise Ratio (SNR) is the worst spatial stream, a second spatial stream of all the spatial streams with a median SNR is the median spatial stream, and a third spatial stream of all the spatial streams with a best SNR is the best spatial stream.

In an embodiment, the UE is further to identify a worst spatial stream based at least in part on determining that a first type of unequal MCS is enabled. In some examples, the UE can identify a median spatial stream based at least in part on determining that a second type of unequal MCS is enabled. In some examples, the UE can identify a best spatial stream based at least in part on determining that a third type of unequal MCS is enabled.

In some examples, the UE can further determine a first type of the unequal MCS is enabled. In an embodiment, the UE can assign a minimum MCS index (MCSₘᵢₙ) to the primary spatial stream based at least in part on determining the first type of the unequal MCS and assign an MCS index for remaining spatial streams in a range from the minimum MCS index (MCSₘᵢₙ) to a combination of the minimum MCS index (MCSₘᵢₙ) and the maximum difference in MCS index allowed across the different spatial streams. The UE can additionally compute a subtraction of the minimum MCS index (MCSₘᵢₙ) from an MCS index associated with an MCS corresponding to an obtained Signal-to-Noise Ratio (SNR) of a predefined (e.g. an n^{th}) spatial stream (SNRₙ). In an embodiment, the UE can determine whether the computed subtraction of the minimum MCS (MCSₘᵢₙ) from the MCS index (MCSₙ) associated with the MCS corresponding to the obtained SNR of the predefined spatial stream (SNRₙ) is less than or equal to the maximum difference in the MCS index allowed across the different spatial streams. In some examples, the UE can assign the MCS index (MCSₙ) with the MCS corresponding to the obtained SNR of the predefined spatial stream (SNRₙ) in response to determining that the computed subtraction of the minimum MCS index (MCSₘᵢₙ) from the MCS index associated with the MCS corresponding to the obtained SNR of the predefined spatial stream (SNRₙ) is less than or equal to the maximum difference in the MCS index allowed across different spatial streams. In some examples, the UE can assign the MCS index (MCSₙ) with the sum of the minimum MCS index (MCSₘᵢₙ) and the maximum difference in the MCS index allowed in response to determining that the computed subtraction of the minimum MCS index (MCSₘᵢₙ) from the MCS index associated with the MCS corresponding to the obtained SNR of the predefined spatial stream (SNRₙ) is not less than or equal to the maximum difference in the MCS index allowed across the different spatial streams.

In some examples, the UE can determine a third type of the unequal MCS is enabled. In an embodiment, the UE can assign a highest MCS index (MCS_{highest}) to the primary spatial stream and assign an MCS index for remaining spatial streams in a range from the highest MCS (MCS_{highest}) to a difference between the maximum difference in the MCS index allowed across the spatial streams and the highest MCS index (MCS_{highest}). In an embodiment, the UE can further compute a subtraction of an MCS index (MCS) corresponding to an obtained Signal-to-Noise Ratio (SNR) of a predefined (e.g., n^{th}) spatial stream (SNRₙ) from the highest MCS index (MCS_{highest}). The UE can also determine whether the computed subtraction is less than or equal to the maximum difference in MCS index allowed across the spatial streams. In an embodiment, the UE can assign the MCS index (MCSₙ) with the MCS index corresponding to the obtained SNR of the predefined spatial stream (SNRₙ) based at least in part on determining that the computed subtraction is less than or equal to the maximum difference in the MCS index allowed across the spatial streams. In some examples, the UE can assign the MCS index (MCSₙ) with the difference between the maximum difference in the MCS index allowed across the spatial streams and the highest MCS index (MCS_{highest}) based at least in part on determining that the computed subtraction is not less than or equal to the maximum difference in the MCS index allowed across the spatial streams.

In an embodiment, the UE can determine a second type of the unequal MCS is enabled. In an embodiment, the UE can assign a median MCS index (MCS_{median}) to the primary spatial stream. In some examples, the UE can determine whether the remaining spatial streams are better than a spatial stream associated with the second type of the unequal MCS. In an embodiment, the UE can assign an MCS index for the remaining spatial streams in a first range from the median MCS index (MCS_{median}) to a combination of the median MCS index (MCS_{median}) and the maximum difference in the MCS index allowed divided by two in response to determining that the remaining spatial streams are better than the spatial stream associated with the second type of unequal MCS. In some examples, the UE can assign the MCS index for the remaining spatial streams in a second range from a difference between the median MCS index (MCS_{median}) and the maximum difference in the MCS index allowed divided by two to the median MCS index (MCS_{median}) in response to determining that the remaining spatial streams are not better than spatial stream associated with the second type of unequal MCS. In an embodiment, the UE can further compute a subtraction of an MCS corresponding to a Signal-to-Noise Ratio (SNR) of a predefined (n^{th}) spatial stream (SNRₙ) from the median MCS index (MCS_{median}). In an embodiment, the UE can determine whether the computed subtraction of the MCS corresponding to the obtained SNR of the predefined spatial stream (SNRₙ) from the median MCS index (MCS_{median}) is less than or equal to the maximum difference in the MCS index allowed across different spatial stream divided by two. In an embodiment, the UE can assign the MCS index (MCSₙ) with the maximum difference in the MCS index allowed across different spatial stream divided by two subtracted from the median MCS index (MCS_{median}) in response to determining that the computed subtraction is not less than or equal to the maximum difference in the MCS index allowed across different spatial stream divided by two and the MCS corresponding to the obtained SNR of the predefined spatial stream (SNRₙ) is less than the median MCS index (MCS_{median}). In some examples, the UE can assign the MCS index (MCSₙ) with a sum of the MCS median index (MCS_{median}) and the the maximum difference in the MCS index allowed across different spatial stream divided by two in response to determining that the computed subtraction is not less than or equal to the maximum difference in the MCS index allowed across different spatial stream divided by two and the MCS corresponding to the obtained SNR of the predefined spatial stream (SNRₙ) is greater than the median MCS index (MCS_{median}). In an embodiment, the UE can assign the MCS index (MCSₙ) with the MCS corresponding to the obtained SNR of the predefined spatial stream (SNRₙ) in response to determining that an absolute value of the computed subtraction is less than or equal to the maximum difference in the MCS index allowed across different spatial stream divided by two.

In an embodiment, the UE can enable the assignment of the at least one MCS index based at least in part on the determined NSS.

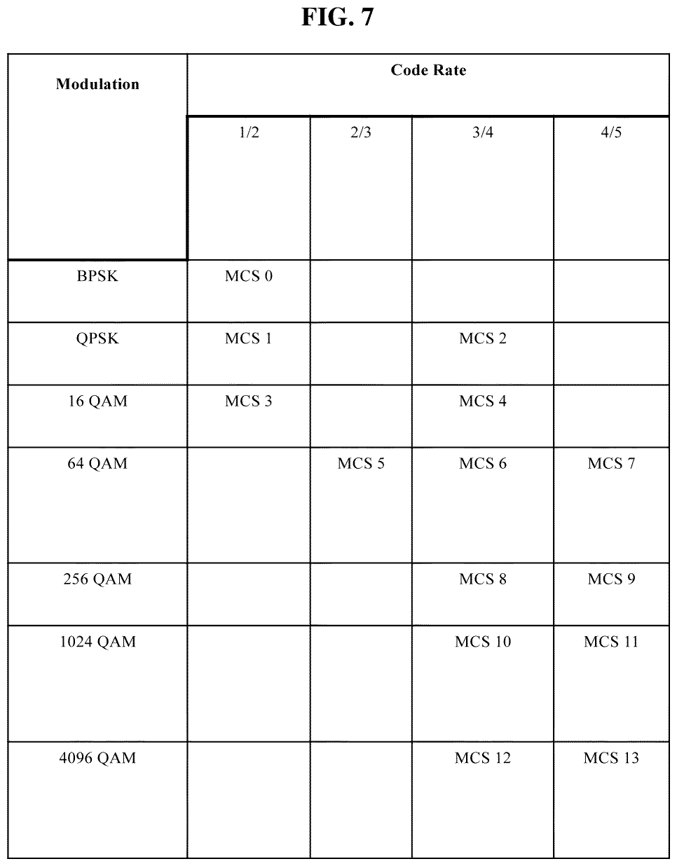

FIG. 7 is an example table for assigning a MCS index, according to an embodiment. For example, FIG. 7 illustrates a potential MCS index (e.g., between MSC0 and MCS 13) based on a modulation scheme (e.g., BPSK, QPSK, and QAM) and a code rate (e.g., ½, ⅔, ¾, and ⅘)

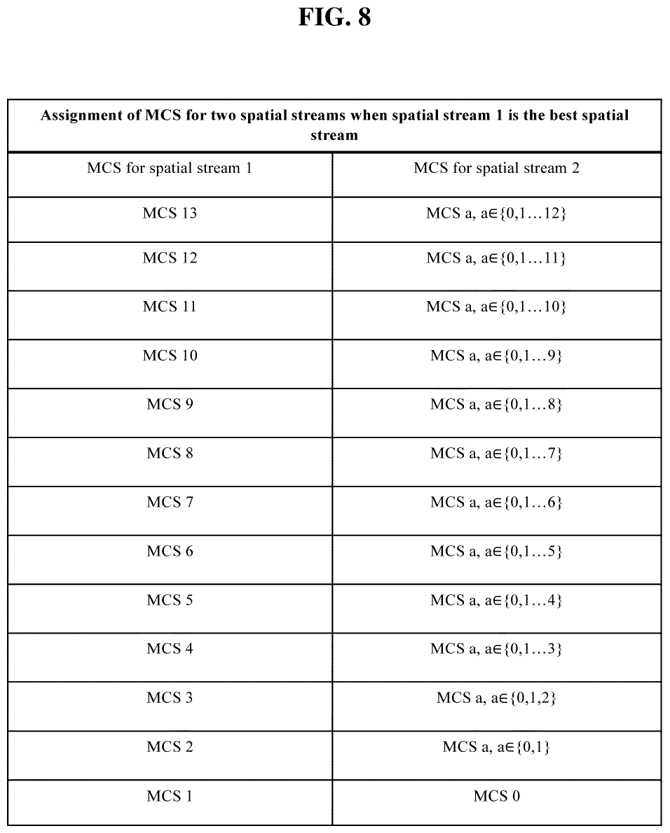

FIG. 8 is an example table for performing possible MCS assignment for two spatial streams, when spatial stream one is the best spatial stream, according to an embodiment. That is, FIG. 8 can illustrate possible MCS for spatial stream 2 if spatial stream 1 has a respective value or vice versa—e.g., if the MCS for the spatial stream 1 is MCS 8, then the MCS for spatial stream 2 is MCSa, α∈{0, 1, 2, 3, 4, 5, 6, 7}.

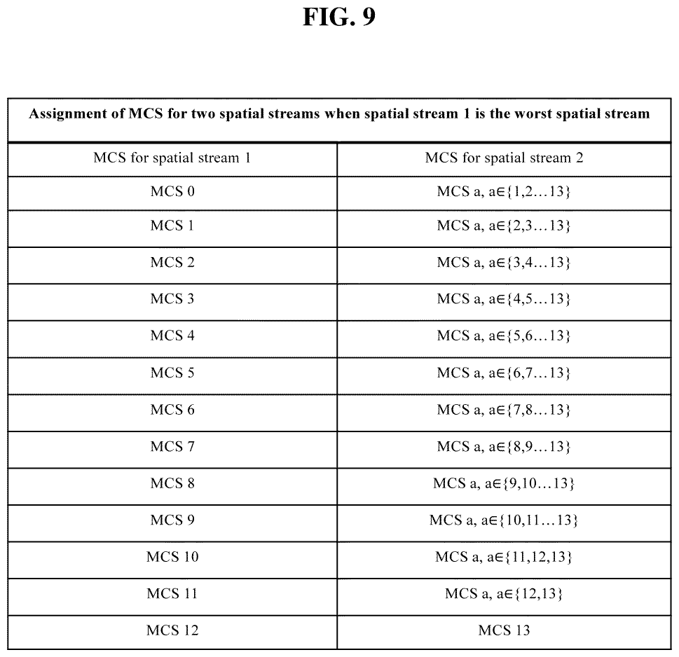

FIG. 9 is an example table for performing possible MCS assignment for two spatial streams, when spatial stream one is the worst spatial stream, according to an embodiment. That is, FIG. 9 can illustrate possible MCS for spatial stream 2 if spatial stream 1 has a respective value or vice versa—e.g., if the MCS for the spatial stream 1 is MCS 8, then the MCS for spatial stream 2 is MCSa, α∈{9, 10, . . . , 13}.

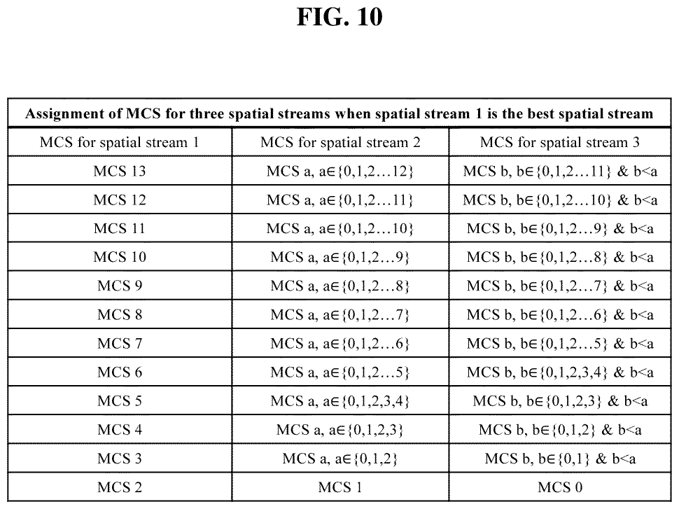

FIG. 10 is an example table for performing possible MCS assignment for three spatial streams, when spatial stream one is the best spatial stream, according to an embodiment. That is, FIG. 10 can illustrate possible MCS for spatial stream 2 and 3 if spatial stream 1 has a respective value or vice versa.

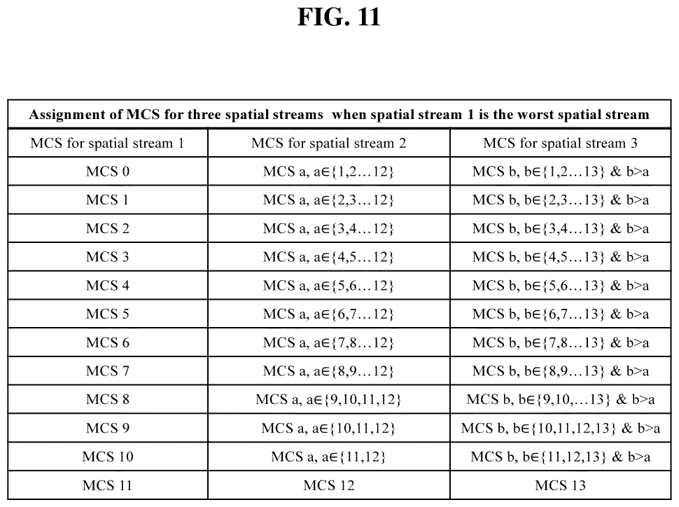

FIG. 11 is an example table for performing possible MCS assignment for three spatial streams, when spatial stream one is the worst spatial stream, according to an embodiment. That is, FIG. 11 can illustrate possible MCS for spatial stream 2 and 3 if spatial stream 1 has a respective value or vice versa.

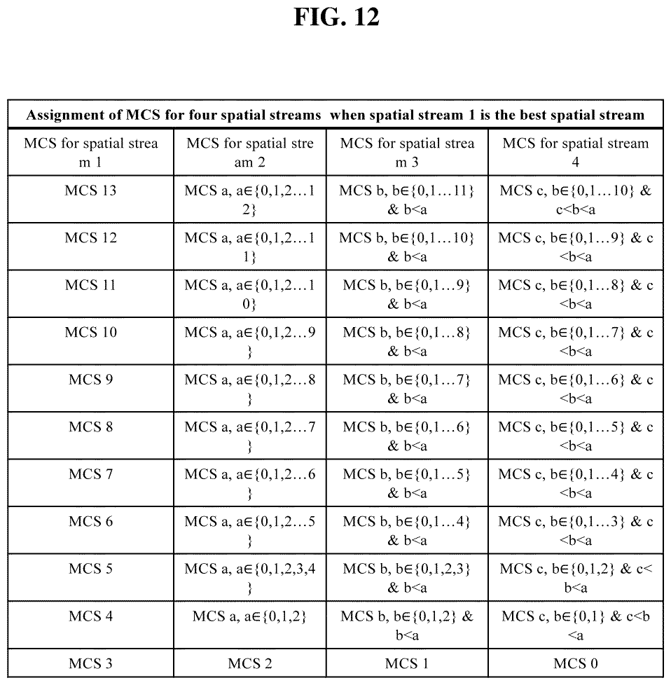

FIG. 12 is an example table for performing possible MCS assignment for four spatial streams, when spatial stream one is the best spatial stream, according to an embodiment. That is, FIG. 12 can illustrate possible MCS for spatial streams 2, 3, and 4 if spatial stream 1 has a respective value or vice versa.

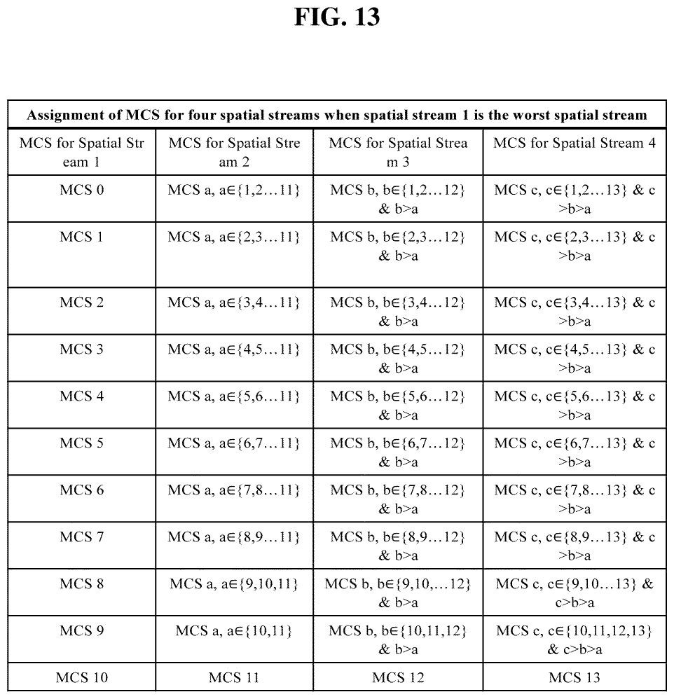

FIG. 13 is an example table for performing possible MCS assignment for four spatial streams, when spatial stream one is the worst spatial stream, according to an embodiment. That is, FIG. 13 can illustrate possible MCS for spatial stream 2, 3, and 4 if spatial stream 1 has a respective value or vice versa.

The disclosure provides a method to enable UEQ-MCS for different spatial streams of a user. The MCS index is assigned to each spatial stream of a user such that the MCS index of all the spatial streams are bound by a maximum difference of diff_MCS. The diff_MCS is either user defined or can be negotiated during setup.

The disclosure provides a method to assign MCS index to each spatial stream of the user. The UE 102 can start with the spatial stream with the worst condition (e.g., MCSₘᵢₙ). The UE 102 assigns the rest of the spatial streams in the range of MCSₘᵢₙ to MCSₘᵢₙ+diff_MCS. For an n^{th} spatial stream, the UE 102 assigns an MCS n^{th} which is equal to MCS (SNR n^{th}), based on determining the MCS (SNR n^{th})−MCSₘᵢₙ≤diff_MCS. For an n^{th} spatial stream, the UE 102 assigns an MCS n^{th} which is equal to MCSₘᵢₙ+diff_MCS, based on determining MCS (SNR n^{th})−MCSₘᵢₙ>diff_MCS, wherein MCS (SNR n^{th}) represents an MCS corresponding to the SNR of the n^{th} spatial stream.

At least one processor 104 individually or collectively executes instructions to cause a device (e.g., a UE 102) to perform the operations disclosed herein. At least one MCS enabling controller 110 individually or collectively executes instructions to cause a device (e.g., a UE 102) to perform the operations disclosed herein. At least one processor 104 and at least one MCS enabling controller 110 collectively execute instructions to cause a device (e.g., a UE 102) to perform the operations disclosed herein. At least one controller in the claims may include at least one processor 104 and/or at least one power saving controller 110.

The various actions, acts, blocks, steps, or the like in the flow charts/diagrams (200, 300, 400, 500, 600) may be performed in the order presented, in a different order or simultaneously. Further, In some examples, some of the actions, acts, blocks, steps, or the like may be omitted, added, modified, skipped, or the like without departing from the scope of the invention. The embodiments disclosed herein can be implemented through at least one software program running on at least one hardware device and performing network management functions to control the network elements. The elements include blocks which can be at least one of a hardware device, or a combination of hardware device and software module.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in an embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

A phrase “at least one of” preceding a series of times, with the terms “and” or “or” to separate any of the times, modifies the list as a whole, rather than each member of the list. The phrase “at least one of” does not require a selection of least one item, rather, the phrase allows a meaning that includes at least one of any one of the items, and/or at least one of any combination of the items, and/or at least one of each of the items. By way of example, each of the phrases “at least one of A, B, and C” or “at least of A, B, or C” refers to Only A, only B, only C, any combination of A, B, and C, and/or at least each of A, B, and C.

What is claimed:

1. A User Equipment (UE) comprising:
at least one controller including processing circuitry; and
memory storing instructions that, when executed by the at least one controller individually or collectively, cause the UE to:
determine a maximum difference in a modulating and coding scheme (MCS) index allowed across different spatial streams per user;
determine a type of unequal MCS enabled at the UE;
identify a primary spatial stream, based on the type of unequal MCS enabled at the UE; and
enable assignment of at least one MCS index to all the spatial streams based on at least one of the maximum difference in the MCS index allowed across different spatial streams per user, the type of unequal MCS to be enabled at the UE, or the identification of the primary spatial stream.

2. The UE of claim 1, wherein the type of unequal MCS enabled at the UE comprises at least one of a first type of unequal MCS, wherein the first type of unequal MCS corresponds to unequal MCS assignment based on a worst spatial stream.

3. The UE of claim 2, wherein the type of unequal MCS enabled at the UE comprises at least one of a second type of unequal MCS, wherein the second type of unequal MCS corresponds to unequal MCS assignment based on a median spatial stream.

4. The UE of claim 3, wherein the type of unequal MCS enabled at the UE comprises at least one of a third type of unequal MCS, wherein the third type of unequal MCS corresponds to unequal MCS assignment based on a best spatial stream.

5. The UE of claim 4, wherein a first spatial stream of all the spatial streams with a lowest Signal-to-Noise Ratio (SNR) is the worst spatial stream, a second spatial stream of all the spatial streams with a median SNR is the median spatial stream, and a third spatial stream of all the spatial streams with a best SNR is the best spatial stream.

6. The UE of claim 1, wherein to identify the primary spatial stream, the instructions, when executed by the at least one controller individually or collectively, cause the UE to perform one of:
identifying a worst spatial stream based at least in part on determining that a first type of unequal MCS is enabled;
identifying a median spatial stream based at least in part on determining that a second type of unequal MCS is enabled; or
identifying a best spatial stream based at least in part on determining that a third type of unequal MCS is enabled.

7. The UE of claim 1, wherein to enable the assignment of unequal MCS to all spatial stream per user, the instructions, when executed by the at least one controller individually or collectively, cause the UE to:
determine a first type of the unequal MCS is enabled;
assign a minimum MCS index to the primary spatial stream based at least in part on determining the first type of the unequal MCS; and
assign an MCS index for remaining spatial streams in a range from the minimum MCS index to a combination of the minimum MCS index and the maximum difference in MCS index allowed across the different spatial streams.

8. The UE of claim 5, wherein to assign the MCS index for the remaining spatial streams, the instructions, when executed by the at least one controller individually or collectively, cause the UE to:
compute a subtraction of the minimum MCS index from an MCS index associated with an MCS corresponding to an obtained Signal-to-Noise Ratio (SNR) of a predefined spatial stream;
determine whether the computed subtraction of the minimum MCS from the MCS index associated with the MCS corresponding to the obtained SNR of the predefined spatial stream is less than or equal to the maximum difference in the MCS index allowed across the different spatial streams;
performing one of:
assign the MCS index with the MCS corresponding to the obtained SNR of the predefined spatial stream in response to determining that the computed subtraction of the minimum MCS index from the MCS index associated with the MCS corresponding to the obtained SNR of the predefined spatial stream is less than or equal to the maximum difference in the MCS index allowed across different spatial streams; or
assign the MCS index with the sum of the minimum MCS index and the maximum difference in the MCS index allowed in response to determining that the computed subtraction of the minimum MCS index from the MCS index associated with the MCS corresponding to the obtained SNR of the predefined spatial stream is not less than or equal to the maximum difference in the MCS index allowed across the different spatial streams.

9. The UE of claim 1, wherein to enable assignment of unequal MCS to all spatial stream per user, the instructions, when executed by the at least one controller individually or collectively, cause the UE to:
determine a third type of the unequal MCS is enabled;
assign a highest MCS index to the primary spatial stream; and
assign an MCS index for remaining spatial streams in a range from the highest MCS to a difference between the maximum difference in the MCS index allowed across the spatial streams and the highest MCS index.

10. The UE of claim 9, to assign the MCS index for the remaining spatial streams, the instructions, when executed by the at least one controller individually or collectively, cause the UE to:
compute a subtraction of an MCS index corresponding to an obtained Signal-to-Noise Ratio (SNR) of a predefined spatial stream from the highest MCS index;
determine whether the computed subtraction is less than or equal to the maximum difference in MCS index allowed across the spatial streams;
perform one of:
assigning the MCS index with the MCS index corresponding to the obtained SNR of the predefined spatial stream based at least in part on determining that the computed subtraction is less than or equal to the maximum difference in the MCS index allowed across the spatial streams; or
assigning the MCS index with the difference between the maximum difference in the MCS index allowed across the spatial streams and the highest MCS index based at least in part on determining that the computed subtraction is not less than or equal to the maximum difference in the MCS index allowed across the spatial streams.

11. The UE of claim 1, wherein to enable assignment of unequal MCS to all spatial stream per user, the instructions, when executed by the at least one controller individually or collectively, cause the UE to:
determine a second type of the unequal MCS is enabled;
assign a median MCS index to the primary spatial stream;
determine whether the remaining spatial streams are better than a spatial stream associated with the second type of the unequal MCS;
performing one of:
assigning an MCS index for the remaining spatial streams in a first range from the median MCS index to a combination of the median MCS index and the maximum difference in the MCS index allowed divided by two in response to determining that the remaining spatial streams are better than the spatial stream associated with the second type of unequal MCS; or
assigning the MCS index for the remaining spatial streams in a second range from a difference between the median MCS index and the maximum difference in the MCS index allowed divided by two to the median MCS index in response to determining that the remaining spatial streams are not better than spatial stream associated with the second type of unequal MCS.

12. The UE of claim 11, the instructions, when executed by the at least one controller individually or collectively, cause the UE to:
compute a subtraction of an MCS corresponding to an Signal-to-Noise Ratio (SNR) of a predefined spatial stream from the median MCS index;
determine whether the computed subtraction of the MCS corresponding to the obtained SNR of the predefined spatial stream from the median MCS index is less than or equal to the maximum difference in the MCS index allowed across different spatial stream divided by two;
perform one of:
assigning the MCS index with the maximum difference in the MCS index allowed across different spatial stream divided by two subtracted from the median MCS index in response to determining that the computed subtraction is not less than or equal to the maximum difference in the MCS index allowed across different spatial stream divided by two and the MCS corresponding to the obtained SNR of the predefined spatial stream is less than the median MCS index;
assigning the MCS index with a sum of the MCS median index and the maximum difference in the MCS index allowed across different spatial stream divided by two in response to determining that the computed subtraction is not less than or equal to the maximum difference in the MCS index allowed across different spatial stream divided by two and the MCS corresponding to the obtained SNR of the predefined spatial stream is greater than the median MCS index; or
assigning the MCS index with the MCS corresponding to the obtained SNR of the predefined spatial stream in response to determining that an absolute value of the computed subtraction is less than or equal to the maximum difference in the MCS index allowed across different spatial stream divided by two.

13. The UE of claim 1, wherein the instructions, when executed by the at least one controller individually or collectively, cause the UE to:
determine, by the UE, a number of spatial streams (NSS) per UE associated with a user, wherein enabling the assignment of the at least one MCS index is based at least in part on the NSS.

14. A method for assigning an unequal modulation and coding scheme (MCS) in a wireless network, comprising:
determining, by a user equipment (UE), a maximum difference in an MCS index allowed across different spatial streams per user;
determining, by the UE, a type of unequal MCS enabled at the UE;
identifying, by the UE, a primary spatial stream, based on the type of unequal MCS enabled at the UE; and
enabling, by the UE, assignment of at least one MCS index to all the spatial streams based on at least one of the maximum difference in the MCS index allowed across different spatial streams per user, the type of unequal MCS enabled at the UE, or the identification of the primary spatial stream.

15. The method of claim 14, wherein the type of unequal MCS enabled comprises at least one of a first type of unequal MCS, a second type of unequal MCS, or a third type of unequal MCS.

16. The method of claim 15, wherein the first type of unequal MCS corresponds to unequal MCS assignment based on a worst spatial stream, the second type of unequal MCS corresponds to unequal MCS assignment based on a median spatial stream, and the third type of unequal MCS corresponds to unequal MCS assignment based on a best spatial stream, and wherein a first spatial stream of all the spatial streams with a lowest Signal-to-Noise Ratio (SNR) is the worst spatial stream, a second spatial stream of all the spatial streams with a median SNR is the median spatial stream, and a third spatial stream of all the spatial streams with a best SNR is the best spatial stream.

17. The method of claim 14, wherein the identifying the primary spatial stream further comprises performing one of:
identifying, by the UE, a worst spatial stream based at least in part on determining that a first type of unequal MCS is enabled;
identifying, by the UE, a median spatial stream based at least in part on determining that a second type of unequal MCS is enabled; or
identifying, by the UE, a best spatial stream based at least in part on determining that a third type of unequal MCS is enabled.

18. The method of claim 14, wherein the enabling the assignment of unequal MCS to all spatial stream per user further comprises:
determining a first type of the unequal MCS is enabled;
assigning a minimum MCS index to the primary spatial stream based at least in part on determining the first type of the unequal MCS; and
assigning an MCS index for remaining spatial streams in a range from the minimum MCS index to a combination of the minimum MCS index and the maximum difference in MCS index allowed across the different spatial streams.

19. The method of claim 14, wherein the assigning the MCS index for the remaining spatial streams further comprises:
computing a subtraction of the minimum MCS index from an MCS index associated with an MCS corresponding to an obtained Signal-to-Noise Ratio (SNR) of a predefined spatial stream;
determining whether the computed subtraction of the minimum MCS from the MCS index associated with the MCS corresponding to the obtained SNR of the predefined spatial stream is less than or equal to the maximum difference in the MCS index allowed across the different spatial streams;
performing one of:
assigning the MCS index with the MCS corresponding to the obtained SNR of the predefined spatial stream in response to determining that the computed subtraction of the minimum MCS index from the MCS index associated with the MCS corresponding to the obtained SNR of the predefined spatial stream is less than or equal to the maximum difference in the MCS index allowed across different spatial streams; or
assigning the MCS index with the sum of the minimum MCS index and the maximum difference in the MCS index allowed in response to determining that the computed subtraction of the minimum MCS index from the MCS index associated with the MCS corresponding to the obtained SNR of the predefined spatial stream is not less than or equal to the maximum difference in the MCS index allowed across the different spatial streams.

20. The method of claim 14, wherein the enabling assignment of unequal MCS to all spatial streams per user further comprises:
determining a third type of the unequal MCS is enabled;
assigning a highest MCS index to the primary spatial stream; and
assigning an MCS index for remaining spatial streams in a range from the highest MCS to a difference between the maximum difference in the MCS index allowed across the spatial streams and the highest MCS index.
